(19) United States
(12) Patent Application Publication
(10) Pub. No.: US 2016/0168451 A1
(43) Pub. Date: Jun. 16, 2016

(54) WELL TREATMENT

(71) Applicant: SCHLUMBERGER TECHNOLOGY CORPORATION, Sugar Land, TX (US)

(72) Inventors: Dmitriy Ivanovich Potapenko, Sugar Land, TX (US); J. Ernest Brown, Sugar Land, TX (US); Theodore Lafferty, Sugar Land, TX (US)

(21) Appl. No.: 14/891,172

(22) PCT Filed: Aug. 15, 2014
(86) PCT No.: PCT/US2014/051167

§ 371 Date: Nov. 13, 2015

Related U.S. Application Data
(60) Provisional application No. 61/873,185, filed on Sep. 3, 2013.

(51) Int. Cl. C09K 8/80; E21B 43/267; E21B 43/26; C09K 8/62

(52) U.S. Cl. CPC C09K 8/80; C09K 8/62; E21B 43/267; E21B 43/26

(57) ABSTRACT

A method for treating a subterranean formation penetrated by a wellbore, comprising: providing a treatment slurry comprising a carrying fluid, a solid particulate and an anchorant; injecting the treatment slurry into a fracture to form a substantially uniformly distributed mixture of the solid particulate and the anchorant; and transforming the substantially uniform mixture into areas that are rich in solid particulate and areas that are substantially free of solid particulate, wherein the solid particulate and the anchorant have substantially dissimilar velocities in the fracture and wherein said transforming results from said substantially dissimilar velocities is provided.

### BACKGROUND

The statements in this section merely provide background information related to the present disclosure and may not constitute prior art.

Fracturing is used to increase permeability of subterranean formations. A fracturing fluid is injected into the wellbore passing through the subterranean formation. A propping agent (proppant) is injected into the fracture to prevent fracture closing and, thereby, to provide improved extraction of extractive fluids, such as oil, gas or water.

The proppant maintains the distance between the fracture walls in order to create conductive channels in the formation. Settling of proppant particles, however, can decrease the conductivity in the fracture. Heterogeneous distribution of proppant particles into a channels and clusters configuration can improve the conductivity in the fracture. Accordingly, there is a demand for further improvements in this area of technology.

### SUMMARY

The disclosed subject matter of the application provides methods for treating subterranean formations penetrated by a wellbore providing non-homogeneous settling resulting in areas of solid particle-rich clusters surrounded by substantially solid particle-free areas.

The disclosed subject matter of the application further provides compositions capable of transforming via settling from a first state of being substantially homogeneously mixed and a second state comprising portions that are rich of solid particulates and portions that are substantially free of solid particulates

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

These and other features and advantages will be better understood by reference to the following detailed description when considered in conjunction with the accompanying drawings.

FIG. 1 schematically illustrates the proppant slurry profile after placement into a hydraulic fracture but before destabilization.

FIG. 2 is a graph illustrating the proppant slurry after in situ channelization during heterogeneous settling inside a hydraulic fracture.

FIG. 3 illustrates a laboratory experiment evidencing the settling of proppant in a slot in fiber loaded foamed fluid.

FIG. 4A illustrates a propped fracture after a conventional treatment with homogeneous proppant settling.

FIG. 4B schematically illustrates a propped fracture after a treatment with heterogeneous proppant settling.

FIG. 5 shows the profile of a fracture after destabilization of the energized fluid according to the present application.

### DETAILED DESCRIPTION OF SOME ILLUSTRATIVE EMBODIMENTS

For the purposes of promoting an understanding of the principles of the disclosure, reference will now be made to some illustrative embodiments of the current application.

Some embodiments of the disclosed subject matter may be described in terms of treatment of vertical wells, but are equally applicable to wells of any orientation. Embodiments may be described for hydrocarbon production wells, but it is to be understood that embodiments may be used for wells for production of other fluids, such as water or carbon dioxide, or, for example, for injection or storage wells. It should also be understood that throughout this specification, when a concentration or amount range is described as being useful, or suitable, or the like, it is intended that any and every concentration or amount within the range, including the end points, is to be considered as having been stated. Furthermore, each numerical value should be read once as modified by the term “about” (unless already expressly so modified) and then read again as not to be so modified unless otherwise stated in context. For example, “a range of from 1 to 10” is to be read as indicating each and every possible number along the continuum between about 1 and about 10. In other words, when a certain range is expressed, even if only a few specific data points are explicitly identified or referred to within the range, or even when no data points are referred to within the range, it is to be understood that the inventors appreciate and understand that any and all data points within the range are to be considered to have been specified, and that the inventors have possession of the entire range and all points within the range. It should also be understood that fracture closure includes partial fracture closure.

It should be understood that, although a substantial portion of the following detailed description may be provided in the context of oilfield hydraulic fracturing operations, other oilfield operations such as cementing, gravel packing, etc., or even non-oilfield well treatment operations, can utilize and benefit as well from the instant disclosure.

In some embodiments according to the disclosure herein, an in situ method and system are provided for increasing fracture conductivity. By “in situ” is meant that channels of relatively high hydraulic conductivity are formed in a fracture after it has been filled with a proppant laden fluid. As used herein, a “hydraulically conductive fracture” is one which has a high conductivity relative to the adjacent formation matrix, whereas the term “conductive channel” refers to both open channels as well as channels filled with a matrix having interstitial spaces for permeation of fluids through the channel, such that the channel has a relatively higher conductivity than adjacent non-channel areas.

As used herein, the term hydraulic fracturing treatment means the process of pumping fluid into a wellbore, e.g. using powerful hydraulic pumps to create enough downhole pressure to crack or fracture the formation. This allows injection of proppant-laden fluid into the formation, thereby creating a region of high-permeability sand through which fluids can flow. The proppant remains in place once the hydraulic pressure is removed and therefore proppants open the fracture and enhances flow into or from the wellbore.

As used herein, the term void means any open space in a geological formation, including naturally occurring open spaces and open spaces formed between the geological formation and one or more objects placed into the geological formation. A void may be a fracture. In certain embodiments, the void may be a fracture with a narrowest dimension of the fracture being from 1 micron to 20 mm. All values and subranges from 1 micron to 20 mm are included and disclosed herein; for example, the narrowest dimension of the fracture may be from a lower limit of 1 micron, 300 microns, 600 microns, 900 microns, 10 mm or 15 mm to an upper limit of 15 microns, 500 microns, 800 microns, 2 mm, 12 mm, or 20 mm. For example, the narrowest dimension of the fracture may be from 1 micron to 20 mm, or from 1 micron to 1 mm, from 1 mm to 20 mm, or from 1 mm to 10 mm, or from 10 mm to 20 mm.

The terms solid particulate includes, for example, proppants.

Embodiments of the disclosed subject matter enable increasing conductivity of a solid particulate, or proppant, pack in a void by forming highly conductive channels by means of proppant settling in the presence of an anchor. Formation of such channels is accomplished by redistributing proppant in a fracturing fluid during anchoring-assisted non-homogeneous settling. Such non-homogeneous settling causes the formation of “islands” or “clusters” or “pillars” of proppant-rich clusters surrounded by substantially proppant-free fluid. Void closure results in creation of channels between the proppant clusters. When such channels interconnect, the void has significantly higher conductivity than the conductivity of a void treated with a treatment slurry which exhibits homogeneous proppant settling.

In embodiments, the conductive channels are formed in situ after placement of the proppant particles in the fracture by differential movement of the proppant particles, e.g., by gravitational settling and/or fluid movement such as fluid flow initiated by a flowback operation, out of and/or away from an area(s) corresponding to the conductive channel(s) and into or toward spaced-apart areas in which clustering of the proppant particles results in the formation of relatively less conductive areas, which clusters may correspond to pillars between opposing fracture faces upon closure.

In some embodiments, methods for treating a subterranean formation penetrated by a wellbore are disclosed; such methods comprising providing a treatment slurry comprising an energized carrier fluid, a solid particulate and an anchor; injecting the treatment slurry into a fracture to form a substantially uniformly distributed mixture of the solid particulate and injecting the anchor; and transforming the substantially uniform mixture into areas that are rich in solid particulate and areas that are substantially free of solid particulate, wherein the solid particulate and the anchor have substantially dissimilar settling, i.e. flow or velocities in the fracture and wherein said transforming results from said substantially dissimilar velocities. Such dissimilar velocities may, in some embodiments, arise, partially or wholly, from the interaction of the anchor with the fracture wall, such interaction including for example, those arising by friction. As used herein, substantially dissimilar means differing by at least 20%. All values and subranges from at least 20% are included herein and disclosed herein. For example, the sedimentation rates of particulate and anchor may differ by at least 20%, or differ by at least 50%, differ by at least 75%, or differ by at least 100%, or differ by at least 150%.

In further embodiments, compositions are disclosed, said compositions comprising: an energized carrier fluid; a plurality of solid particulates; and an anchor; wherein the composition is capable of transforming via settling from a first state of being substantially homogeneously mixed and a second state comprising portions that are rich in the solid particulates and portions that are substantially free of the solid particulates. Such transformation may, in some embodiments, arise, partially or wholly, from differing settling rates of anchor and solid particulates. Such differing settling rates may, in some embodiments, arise partially or wholly from the interaction of the anchor with the fracture wall, such interaction including for example, those arising by friction.

Further embodiments disclose methods comprising: providing a slurry comprising an energized carrier fluid, a solid particulate and an anchor; flowing the slurry into a void to form a substantially uniformly distributed mixture of the solid particulate and the anchor; and transforming the substantially uniformly distributed mixture into areas that are rich in solid particulate and areas that are substantially free of solid particulate, wherein the solid particulate and the anchor have substantially dissimilar settling, or flow, velocities in the void and wherein said transforming results from said substantially dissimilar velocities. Such dissimilar velocities may, in some embodiments, arise, partially or wholly, from the interaction of the anchor with the fracture wall, such interaction including for example, those arising by friction.

Further embodiments disclose methods of designing a treatment, comprising: considering a fracture dimension; selecting an anchor having a dimension comparable to the fracture width dimension; selecting a solid particulate having a substantially different settling velocity from the anchor; formulating a treatment fluid comprising the solid particulate and the anchor such that the treatment fluid is capable of transforming via settling from a first state of being substantially homogeneously mixed and a second state comprising portions that are rich of the solid particulates and portions that are substantially free of the solid particulates; and pumping the treatment fluid into a well to create and/or enlarge the fracture.

As used herein, substantially free of a component means having less than 40% such component. All individual values and subranges of less than 40% are included and disclosed herein. For example, substantially free of such component may be less than 40% such component, or less than 20% such component, or less than 10% such component, or less than 5% such component, or less than 2.5% such component, or less than 1.25% such component, or less than 0.625% such component.

As used herein, rich in a component means having greater than 40% such component. All individual values and subranges of greater than 40% are included and disclosed herein. For example, rich in such component may be greater than 40% such component, or greater than 60% such component, or greater than 90% such component, or greater than 95% such component, or greater than 97% such component, or greater than 98% such component.

All embodiments disclosed may contain an energized carrier fluid with at least one additive selected from the group consisting of viscosifiers, gelling agents and rheological agents. In some embodiments, the carrier fluid is energized with carbon dioxide. In some embodiments, the carrier fluid is energized with air. In some embodiments, the carrier fluid is energized with nitrogen. Said carrier fluid may also be energized with helium, argon, or hydrocarbon gases (such as methane, ethane, propane, butane, pentane, hexane, heptane . . . ), and mixtures thereof.

In some embodiments, the energized carrier fluid comprises a foam quality effective to facilitate fluid loss control in the fracture.

In some embodiments, the energized carrier fluid comprises a foam quality effective to increase viscosity of the stabilized slurry and facilitate formation of a relatively wider fracture.

In some embodiments, the method may further comprise expanding gas in the carrier fluid to drive flowback through the proppant pack to the wellbore.

In some embodiments, the energized carrier fluid comprises a foam quality effective to promote slot flow of the solids in the fracture.

In some embodiments, the energized carrier fluid comprises surfactant to change wettability of a surface of the formation.

As used herein, the terms “treatment fluid” or “wellbore treatment fluid” are inclusive of “fracturing fluid” or “treatment slurry” and should be understood broadly. These may include a liquid, a solid, a gas, and combinations thereof, as will be appreciated by those skilled in the art.

For purposes of this disclosure, the terms “energized fluid” and “foam” refer to a fluid which when subjected to a low pressure environment liberates or releases gas from solution or dispersion, for example, a liquid containing dissolved gases. Foam or energized fluids are stable mixture of gases and liquids that form a two-phase system. Foam and energized fracturing fluids are generally described by their foam quality, i.e. the ratio of gas volume to the foam volume (fluid phase of the treatment fluid), i.e., the ratio of the gas volume to the sum of the gas plus liquid volumes). If the foam quality is between 52% and 95%, the energized fluid is usually called foam. Above 95%, foam is generally changed to mist. In the present patent application, the term “energized fluid” also encompasses foams and refers to any stable mixture of gas and liquid, regardless of the foam quality. In embodiments, the foam quality is from 20% to 95%, it may be from 50 to 90%, it may also be from 70 to 92%. Energized fluids comprise any of:
(a) Liquids that at bottom hole conditions of pressure and temperature are close to saturation with a species of gas. For example the liquid can be aqueous and the gas nitrogen or carbon dioxide. Associated with the liquid and gas species and temperature is a pressure called the bubble point, at which the liquid is fully saturated. At pressures below the bubble point, gas emerges from solution;
(b) Foams, consisting generally of a gas phase, an aqueous phase and a solid phase. At high pressures the foam quality is typically low (i.e., the non-saturated gas volume is low), but quality (and volume) rises as the pressure falls. Additionally, the aqueous phase may have originated as a solid material and once the gas phase is dissolved into the solid phase, the viscosity of solid material is decreased such that the solid material becomes a liquid; or
(c) Liquefied gases.

In some embodiments, the energized carrier fluid may have a density, depending on the foam quality and the density of the liquid and gaseous components for example, from 0.05 to 1.2 g/mL, or less than 1.1 g/mL, or less than 1 g/mL, or less than 0.9 g/mL, or less than 0.8 g/mL, or less than 0.7 g/mL, or less than 0.6 g/mL, or less than 0.5 g/mL, or less than 0.4 g/mL, or less than 0.3 g/mL, or less than 0.2 g/mL, or less than 0.1 g/mL.

The treatment fluid may additionally or alternatively include, without limitation, friction reducers, clay stabilizers, biocides, crosslinkers, breakers, corrosion inhibitors, and/or proppant flowback control additives. The treatment fluid may further include a product formed from degradation, hydrolysis, hydration, chemical reaction, or other process that occur during preparation or operation.

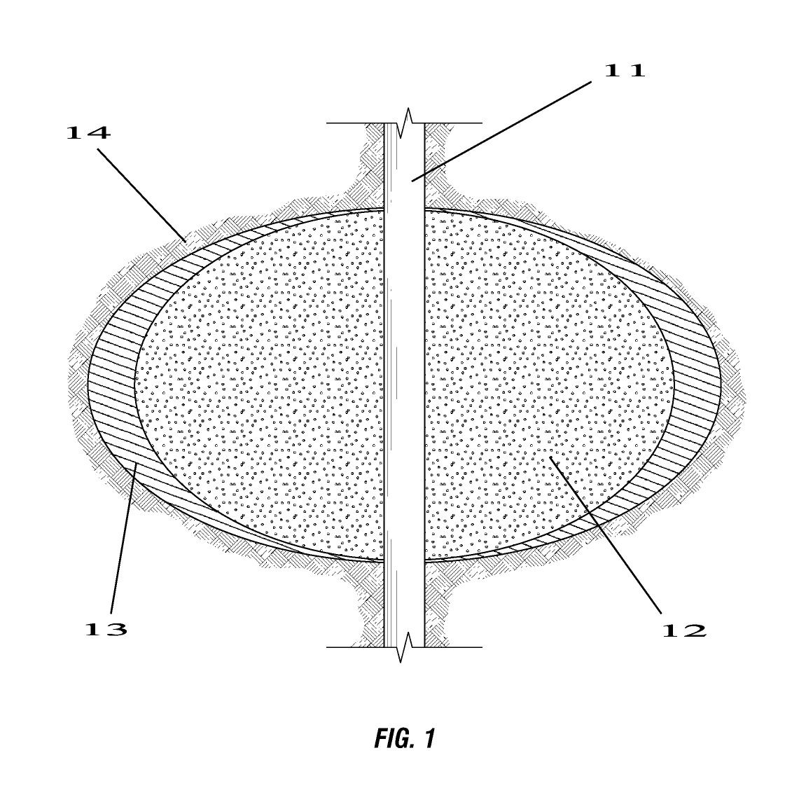

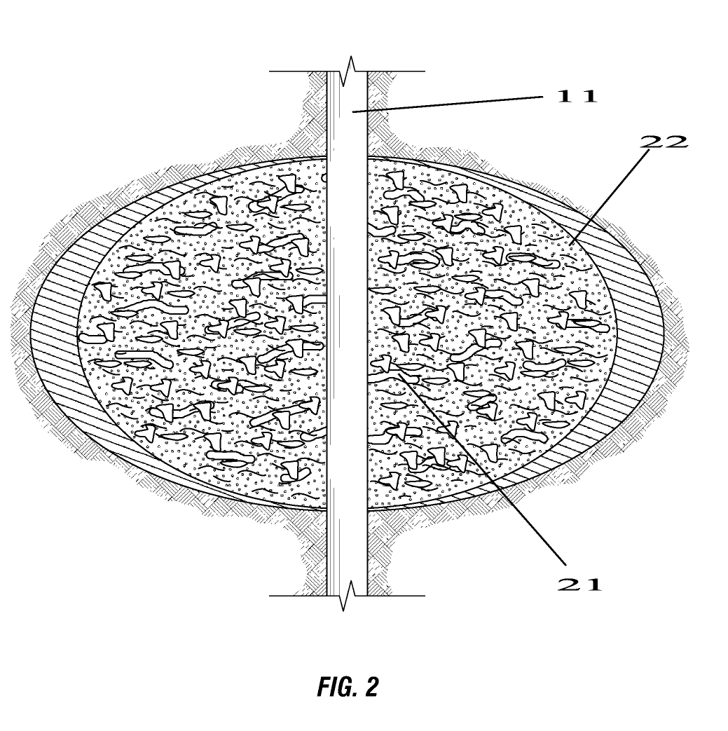

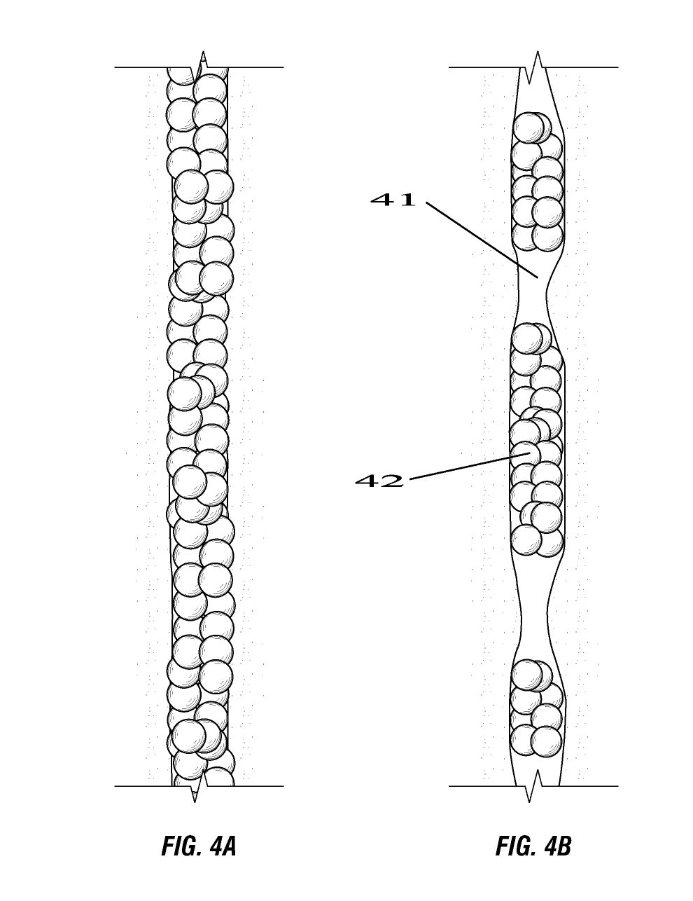

In embodiments the energized fluid is pumped above the fracture pressure to form a fracture in the formation, the energized fluid carrying solid praticles; once placed, the energized fluid is allowed to destabilize in the fracture thus forming highly conductive channels by mean of proppant settling in the presence of anchors during the destabilization of said fluid. Without wishing to be bound by any theory, it is believed that formation of such channels may be accomplished by redistributing of propping agent in a said fracturing fluid during its anchor-assisted non-homogeneous settling. Such non-homogeneous settling yields formation of “islands” and/or “pillars” of proppant-rich clusters surrounded by substantially proppant-free fluid. This phenomenon is summarized in FIGS. 1 and 2. FIG. 1 displays the state of the particles laden energized fluid (12) just after placement, through a wellbore (11) in the fracture (13) created in the formation (14), whereas FIG. 2 is a schematic of the formation of the pillars during the destabilization of the energized fluid; it is readily apparent that the energized fluid (12) is destabilized leaving some proppant-rich clusters (15). Morevoer, it is believed that the destabilization of the energized fluid and/or foamed fluid results in creation of gas bubbles which are getting entrapped into the structure of these proppant rich clusters (15) increasing their stability to settling (this is evidence here after in Example 1). Further fracture closure results in the creation of highly conductive channels (41) between the proppant clusters (42) (FIG. 4B). Obtained fractures have significantly higher fracture conductivity than fractures propped with a conventional fracture treatment with homogeneous proppant settling (FIG. 4A).

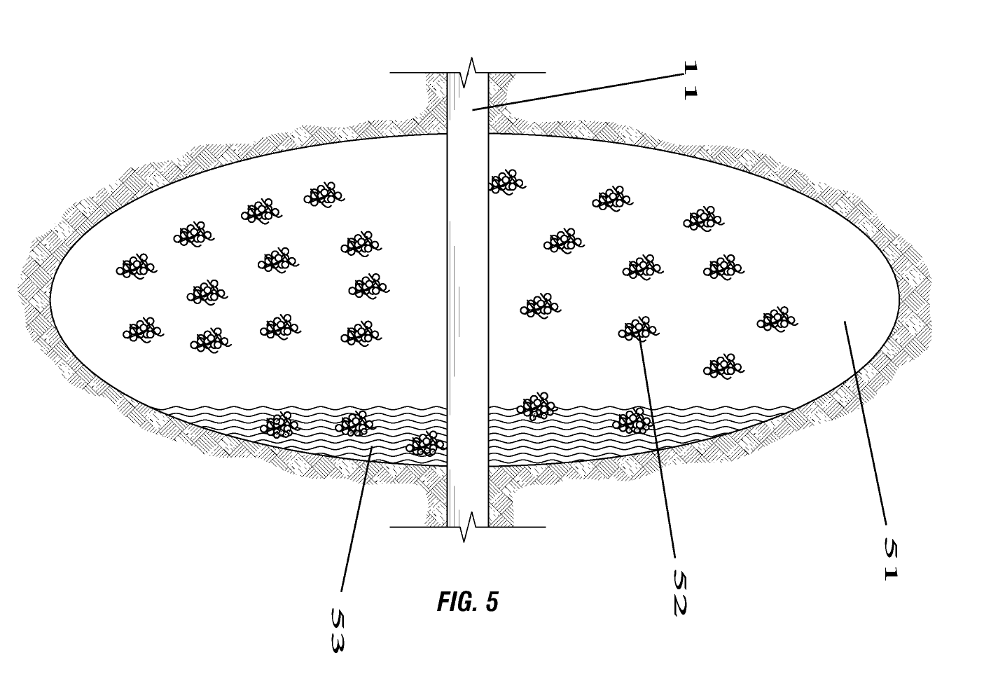

In embodiments, when the energized fluid is of high initial foam quality, such as higher than 70% foam, its destabilization may result in forming of a substantially clean portion (liquid-free) of a fracture with distributed clusters of solids and a portion of a fracture containing liquid phase corresponding to the destabilized foam. The productivity of such fracture, after closure, is typically very high thanks to the high level of clean up. This is schematically exemplified in FIG. 5. Upon destabilization of the energized fluid (53), the stability of the proppant clusters (52) in the substantially liquid-free portion(s) (51) of the fracture may additionally be supported by capillary forces. Such forces are caused by small portion of liquid phase left in structure of the said proppant clusters. These capillary forces may be controlled by introducing wettability agents known to those skilled in the art.

In embodiments, the energized fluid, that at the time of injecting, possesses a property inconsistent with channelization and subsequently is transformed to be consistent with channelization. For example, the treatment slurry may have a viscosity, at the time of injecting, such that it enables the placement of solid particulates into a void, e.g. greater than 50 cP at 100 s⁻¹ and at the same time a viscosity such that it minimizes the chance of channelization via settling, e.g. greater than 500,000 cP at 0.001 to 1 s⁻¹. Subsequently, the viscosity may be changed, e.g., by introduction of a viscosity breaker such that the viscosity is consistent with channelization. In yet a further embodiment, the energized fluid may contain a combination of two or more liquid phase, for example a crosslinked gel and a linear gel, wherein, at the time of injecting, at least one of the phases is inconsistent with channelization and at least one of the phases is consistent with channelization. In such embodiments, subsequent to the injecting, those fluids inconsistent with channelization may be destroyed or broken thereby allowing channelization to occur. Examples of such systems may be solutions of crosslinked guar and viscoelastic surfactants wherein de-crosslinking may occur by lowering the pH or by addition of oxidative breakers. Another example may be solutions of crosslinked guar with borate and polyacrylamide polymers. The breaking may be done by using an oxidative breaker or by using a delayed agent such as for example an acid precursor. Different types of breaker may be combined in order to break the gel in successive phase. The breaking of the gel will typically result in the destabilization of the energized fluid thus promoting the formation of cluster. Thereafter, during fracture closure, the pressure applied will even further strengthen the strength of such clusters and/or pillars.

The liquid phase of the fluid suitable for use in all embodiments of the disclosed subject matter include any fluid useful in fracturing fluids, including, without limitation, gels, slickwater, and viscoelastic surfactants. In further embodiments, the carrying fluids may comprise linear fluids, e.g. non-crosslinked fluids.

In an alternative, all embodiments disclosed may contain a liquid phase of the fluid comprising a crosslinked fluid such as a crosslinked polysaccharide and/or crosslinked polyacrilamide. Any appropriate cross linking agent may be used in forming the crosslinked fluid, including, for example, boron and its salts, salts or other compounds of transition metals such as chromium and copper, titanium, antimony, aluminum, zirconium, and organic crosslinkers, such as glutaraldehyde.

In an alternative, all embodiments disclosed the liquid phase of the fluid may be a viscoelastic surfactant (VES) or emulsion. In further embodiments, the slurry or composition further comprises one or more breaker additives for reducing the viscosity of the liquid phase.

In further embodiments, the solid particulates have an aspect ratio (the ratio of the largest dimension to the smallest dimension) of less than or equal to 6. All values and subranges from less than or equal to 6 are included herein and disclosed herein. For example, the solid particulate aspect ratio may be less than or equal to 6, or less than or equal to 5.5, or less than or equal to 5.

In further embodiments, the solid particulates have density from 0.1 g/cm³ to 10 g/cm³. All values and subranges from 0.1 g/cm³ to 10 g/cm³ are included herein and disclosed herein. For example, the solid particulate density may be from a lower value of 0.1, 1, 3, 5, 7, or 9 g/cm³ to an upper value of 2, 4, 6, 8, or 10 g/cm³. For example, the solid particulate density may be from 1 g/cm³ to 5 g/cm³, or from 2 g/cm³ to 4 g/cm³.

In further embodiments, the density of the solid particulate is more than the density of the energized carrier fluid.

In further embodiments, the anchor is selected from the group of solid particles having an aspect ratio greater than 6. All values and subranges from greater than 6 or disclosed and included herein. For example, the anchor may have an aspect ratio of greater than 6, or greater than or equal to 20, or greater than or equal to 40, or greater than or equal to 50.

As used herein, “anchorant” refers to a material, a precursor material, or a mechanism, that inhibits settling, or preferably stops settling, of particulates or clusters of particulates in a fracture, whereas an “anchor” refers to an anchorant that is active or activated to inhibit or stop the settling. In some embodiments, the anchorant may comprise a material, such as fibers, flocs, flakes, discs, rods, stars, etc., for example, which may be heterogeneously distributed in the fracture and have a different settling rate, and/or cause some of the first solid particulate to have a different settling rate, which may be faster or preferably slower with respect to the first solid particulate and/or clusters. As used herein, the term “flocs” includes both flocculated colloids and colloids capable of forming flocs in the treatment slurry stage.

In some embodiments, the anchorant may adhere to one or both opposing surfaces of the fracture to stop movement of a proppant particle cluster and/or to provide immobilized structures upon which proppant or proppant cluster(s) may accumulate. In some embodiments, the anchors may adhere to each other to facilitate consolidation, stability and/or strength of the formed clusters.

In some embodiments, the anchorant may comprise a continuous concentration of a first anchorant component and a discontinuous concentration of a second anchorant component, e.g., where the first and second anchorant components may react to form the anchor as in a two-reactant system, a catalyst/reactant system, a pH-sensitive reactant/pH modifier system, or the like.

In some embodiments, the anchorant may form lower boundaries for particulate settling.

In further embodiments, the anchor has a density between 0.1 g/cm³ to 10 g/cm³. All values and subranges from 0.1 g/cm³ to 10 g/cm³ are included herein and disclosed herein. For example, the anchor density may be from a lower value of 0.1, 1, 3, 5, 7, or 9 g/cm³ to an upper value of 2, 4, 6, 8, or 10 g/cm³. For example, the anchor density may be from 1 g/cm³ to 5 g/cm³, or from 2 g/cm³ to 4 g/cm³.

In further embodiments, the density of the anchor is less than the density of the energized carrier fluid.

The solid particulates may have any size or size distribution in the range from 10 nm to 5 mm. All values and subranges from 10 nm to 5 mm are included and disclosed herein. For example, the solid particulates may have a size from 10 nm to 5 mm, or from 0.1 mm to 2 mm, or from 0.1 mm to 5 mm, or from 10 nm to 0.001 mm, or from 0.001 mm to 5 mm, or from 0.0005 mm to 5 mm, or from 1000 nm to 1 mm.

The solid particulates and anchor may have any shape provided the aspect ratio requirements are met, including fibers, tubes, irregular beads, flakes, ribbons, platelets, rods, tubes or any combination of two or more thereof.

Any proppant material meeting the aspect ratio of less than or equal to 6 and useful in well treatment fluids may be used. Exemplary proppants include ceramic proppant, sand, bauxite, glass beads, crushed nuts shells, polymeric proppant, and mixtures thereof.

In some embodiments, the conductive channels extend in fluid communication from adjacent a face of in the formation away from the wellbore to or to near the wellbore, e.g., to facilitate the passage of fluid between the wellbore and the formation, such as in the production of reservoir fluids and/or the injection of fluids into the formation matrix. As used herein, “near the wellbore” refers to conductive channels coextensive along a majority of a length of the fracture terminating at a permeable matrix between the conductive channels and the wellbore, e.g., where the region of the fracture adjacent the wellbore is filled with a permeable solids pack as in a high conductive proppant tail-in stage, gravel packing or the like.

In further embodiments, the solid particulates have an average particle size from 1 micron to 5000 microns. All values and subranges from 1 to 5000 microns are included and disclosed herein; for example, the solid particulate has an average particle size from a lower limit of 1, 300, 900, 2000, 2400, 3300 or 4800 microns to an upper limit of 200, 700, 1500, 2200, 2700, 3500 or 5000 microns. For example, the solid particulates have an average particle size from 1 to 5000 microns, or from 1 to 2500 microns, or from 2500 to 5000 microns, or from 1 micron to 1 mm, or from 10 microns to 800 microns. As used herein, the term average particle size refers to the average size of the largest dimension of the solid particulate.

In further embodiments, the largest dimension of the anchor particles is comparable to the narrowest dimension of the void, or fracture. As used herein, comparable means not differing by more than 20 fold. For example, the solid particulates and/or anchor may have a size from 0.05 to 20 fold of the narrowest dimension of the void (e.g. fracture width), or from 0.1 to 10 fold of the narrowest dimension of the void (e.g. fracture width), or from 0.33 to 3 fold of the narrowest dimension of the void (e.g. fracture width). The largest dimension of the anchor may also be comparable to the narrowest dimension of the void, or fracture. For example, if the fracture narrowest dimension, i.e. width, is 2 mm, the average largest dimension of the anchor may be between 0.1 and 40 mm. In various embodiments, expected void widths range from 1 micron to 20 mm. All individual values and subranges from 1 micron to 20 mm are disclosed and included herein.

In further embodiments, the largest dimension of the anchor is from 0.5 micron to 50 mm. All values and subranges from 0.5 microns to 50 mm; for example, the anchor largest dimension may be from a lower limit of 0.5 microns, 100 microns, 500 microns, 900 microns, 20 mm or 40 mm to an upper limit of 10 microns, 250 microns, 750 microns, 10 mm, 30 mm or 50 mm. For example, the anchor largest dimension may be from 0.5 micron to 50 mm, or from 1 mm to 20 mm, or from 0.5 microns to 20 mm, or from 20 to 50 mm, or from 0.5 microns to 30 mm.

In further embodiments, the solid particulates comprise a mixture or blend of two or more particulate solids. For example, the solid particulates may comprise a first solid particulate type having a first average particle size, a second solid particulate type having a second average particle size, a third solid particulate type having a third average particle size, and so on. Alternatively, the two or more solid particulate types may have different densities, shapes, aspect ratios, structures, compositions and/or chemical properties.

In further embodiments, some or all of the solid particulates and/or anchor are made of degradable, meltable, soluble or dissolvable materials. In another embodiment, the treatment slurry further comprises one or more agent(s) that accelerate or control degradation of degradable solid particulates. For example, NaOH, CaCO₃ and Ca(OH)₂ may be added to the treatment slurry to control degradation of particulate materials comprising polylactic acid. Likewise, an acid may be used to accelerate degradation for particulate materials comprising polysaccharides and polyamides.

In some embodiments, the anchorant may comprise a degradable material. In some embodiments, the anchorant is selected from the group consisting of polylactic acid (PLA), polyglycolic acid (PGA), polyethylene terephthalate (PET), polyester, polyamide, polycaprolactam and polylactone, poly(butylene) succinate, polydioxanone, glass, ceramics, carbon (including carbon-based compounds), elements in metallic form, metal alloys, wool, basalt, acrylic, polyethylene, polypropylene, novoloid resin, polyphenylene sulfide, polyvinyl chloride, polyvinylidene chloride, polyurethane, polyvinyl alcohol, polybenzimidazole, polyhydroquinone-diimidazopyridine, poly(p-phenylene-2,6-benzobisoxazole), rayon, cotton, cellulose, or other natural fibers, rubber, sticky fiber, or a combination thereof. In some embodiments the anchorant may comprise acrylic fiber. In some embodiments the anchorant may comprise mica.

In some embodiments, the anchorant may comprise an expandable material, such as, for example, swellable elastomers, temperature expandable particles, Examples of oil swellable elastomers include butadiene based polymers and copolymers such as styrene butadiene rubber (SBR), styrene butadiene block copolymers, styrene isoprene copolymer, acrylate elastomers, neoprene elastomers, nitrile elastomers, vinyl acetate copolymers and blends of EV A, and polyurethane elastomers. Examples of water and brine swellable elastomers include maleic acid grafted styrene butadiene elastomers and acrylic acid grafted elastomers. Examples of temperature expandable particles include metals and gas filled particles that expand more when the particles are heated relative to silica sand. In some embodiments, the expandable metals can include a metal oxide of Ca, Mn, Ni, Fe, etc. that reacts with the water to generate a metal hydroxide which has a lower density than the metal oxide, i.e., the metal hydroxide occupies more volume than the metal oxide thereby increasing the volume occupied by the particle. Further examples of swellable inorganic materials can be found in U.S. Application Publication Number US 20110098202, which is hereby incorporated by reference in its entirety. An example for gas filled material is EXPANCEL™ microspheres that are manufactured by and commercially available from Akzo Nobel of Chicago, Ill. These microspheres contain a polymer shell with gas entrapped inside. When these microspheres are heated the gas inside the shell expands and increases the size of the particle. The diameter of the particle can increase 4 times which could result in a volume increase by a factor of 64.

In further embodiments, the solid particulates may be a proppant. Any proppant material may be used, including, for example, sand, glass beads, ceramic proppants, polymeric beads, or hollow glass spheres, and combinations thereof.

In further embodiments, the velocities are settling velocities.

In further embodiments, the transforming the substantially uniform mixture into areas that are rich in solid particulate and areas that are substantially free of solid particulate takes place during a forced fracture closure or during post-job well flowback.

In further embodiments, the solid particulates and the anchor have different shapes, sizes, densities or a combination thereof.

In further embodiments, the anchor is a fiber, a flake, a ribbon, a platelet, a rod, or a combination thereof.

In further embodiments, the anchor is a fiber.

In further embodiments, the anchor is a degradable material.

In further embodiments, the anchor is selected from the group consisting of polylactic acid, polyester, polycaprolactam, polyamide, polyglycolic acid, polyterephthalate, cellulose, wool, basalt, glass, rubber, or a combination thereof.

In further embodiments, the transforming is achieved by allowing the substantially uniformly dispersed solid particulate (and anchor) to settle in the fracture for a period of time.

In further embodiments, the injecting is achieved by pumping the treatment slurry under a pressure sufficient to create the fracture or maintain the fracture open in the subterranean formation.

In further embodiments, the transforming is achieved before flow back of the treatment fluid.

In further embodiments, the transforming is achieved before fracture closure.

In further embodiments, the substantially uniformly distributed mixture is formed in at least a portion of the void, or fracture.

In further embodiments, the transforming of the substantially uniform mixture into areas that are rich in solid particulate and areas that are substantially free of solid particulate happens in at least a portion of the void (e.g. fracture).

In some embodiments, the method may also include forming bridges with the anchorant-rich modes in the fracture and forming conductive channels between the bridges with the anchorant-lean modes.

In further embodiments, the anchor has a substantially dissimilar settling characteristic from that of the solid particulate. Without being bound by any particular theory, it is currently believed that the dissimilar settling characteristics may arise from one or more of the following: differences in shape, density or size, and interactions between the void walls and the anchor and/or solid particulate, and combinations thereof.

In further embodiments, the solid particulates are present in the slurry in an amount of less than 35 vol %, or in an amount of less than 22 vol %. All values and subranges of less than 35 vol % are included and disclosed herein. For example the solid particulate may be present in an amount of 35 vol %, or less than 22 vol %, or less than 18 vol %, or less than 15 vol %, or less than 12.

In further embodiments, the anchor is present in the treatment slurry in an amount of less than 5 vol %. All individual values and subranges from less than 5 vol % are included and disclosed herein. For example, the amount of anchor may be from 0.05 vol % less than 5 vol %, or less than 1 vol %, or less than 0.5 vol %. The anchor may be present in an amount from 0.5 vol % to 1.5 vol %, or in an amount from 0.01 vol % to 0.5 vol %, or in an amount from 0.05 vo1 % to 0.5 vol %.

In further embodiments, the anchor is a fiber with a length from 1 to 50 mm, or more specifically from 1 to 20 mm, and a diameter of from 1 to 75 microns, or from 1 to 50 microns, or more specifically from 1 to 20 microns. All values and subranges from 1 to 50 mm are included and disclosed herein. For example, the fiber anchor length may be from a lower limit of 1, 3, 5, 7, 9, 19, 29 or 49 mm to an upper limit of 2, 4, 6, 8, 10, 20, 30 or 50 mm. The fiber anchor length may range from 1 to 50 mm, or from 1 to 10 mm, or from 1 to 7 mm, or from 3 to 10 mm, or from 2 to 8 mm. All values from 1 to 50 microns are included and disclosed herein. For example, the fiber anchor diameter may be from a lower limit of 1, 4, 8, 12, 16, 20, 30, 40, or 49 microns to an upper limit of 2, 6, 10, 14, 17, 22, 32, 42 or 50 microns. The fiber anchor diameter may range from 1 to 50 microns, or from 10 to 50 microns, or from 1 to 15 microns, or from 2 to 17 microns.

In further embodiments, the anchor is a fiber with a length from 0.001 to 1 mm and a diameter of from 10 nanometers (nm) to 5 millimeters. All individual values from 0.001 to 1 mm are disclosed and included herein. For example, the anchor fiber length may be from a lower limit of 0.001, 0.01, 0.1 or 0.9 mm to an upper limit of 0.009, 0.07, 0.5 or 1 mm. All individual values from 10 nanometers (nm) to 5 millimeters are included and disclosed herein. For example, the fiber anchor diameter may range from a lower limit of 50, 60, 70, 80, 90, 100, or 500 nanometers to an upper limit of 500 nanometers, 1 micron, or 10 microns.

In further embodiments, the solid particulate has particles with size from 0.001 to 1 mm. All individual values from 0.001 to 1 mm are disclosed and included herein. For example, the solid particulate size may be from a lower limit of 0.001, 0.01, 0.1 or 0.9 mm to an upper limit of 0.009, 0.07, 0.5 or 1 mm. Here particle size is defined is the largest dimension of the grain of said particle.

In further embodiments, the anchor is a fiber with a length of from 0.5 to 5 times the width (i.e. smallest dimension) of a subterranean void to be treated with the treatment slurry. In various embodiments, expected void widths range from 1 micron to 20 mm. All individual values and subranges from 1 micron to 20 mm are disclosed and included herein.

In further embodiments, the amount of solid particulates and anchor is designed to prevent bridging and screenout. Such designing may include modeling using geotechnical model which would define expected fracture geometry (width) and flow conditions on the fracture during the treatment so as to determine the solid particulate and anchor amounts to prevent bridging and to allow heterogeneous channelization.

Although the preceding description has been described herein with reference to particular means, materials and embodiments, it is not intended to be limited to the particulars disclosed herein; rather, it extends to all functionally equivalent structures, methods and uses, such as are within the scope of the appended claims.

### EXAMPLES

Any element in the examples may be replaced by any one of numerous equivalent alternatives, only some of which are disclosed in the specification. Although only a few example embodiments have been described in detail above, those skilled in the art will readily appreciate that many modifications are possible in the example embodiments without materially departing from the concepts described herein. The disclosed subject matter may be embodied in other forms without departing from the spirit and the essential attributes thereof, and, accordingly, reference should be made to the appended claims, rather than to the foregoing specification, as indicating the scope of the disclosed subject matter. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

### Example 1 and Comparative Example 1

### Formation of Proppant-Rich Clusters and Proppant-Free Channels by Enabling Heterogeneous Proppant Settling in the Presence of Anchor in an Energized Fluid

The energized fluid as disclosed was laboratory tested using artificial voids created between two plates having a space there between. The simulated fracture width was 3 mm and the plates dimension were 15.2 cm by 20.3 cm (6 by 8 inches). As would be understood, other sizes of plates could be used. The plates were made from a transparent acrylic glass, so that the settling and distribution of the treatment slurry may be observed over time. 100mesh sandpaper was glued to the back wall of the slot to provide roughness

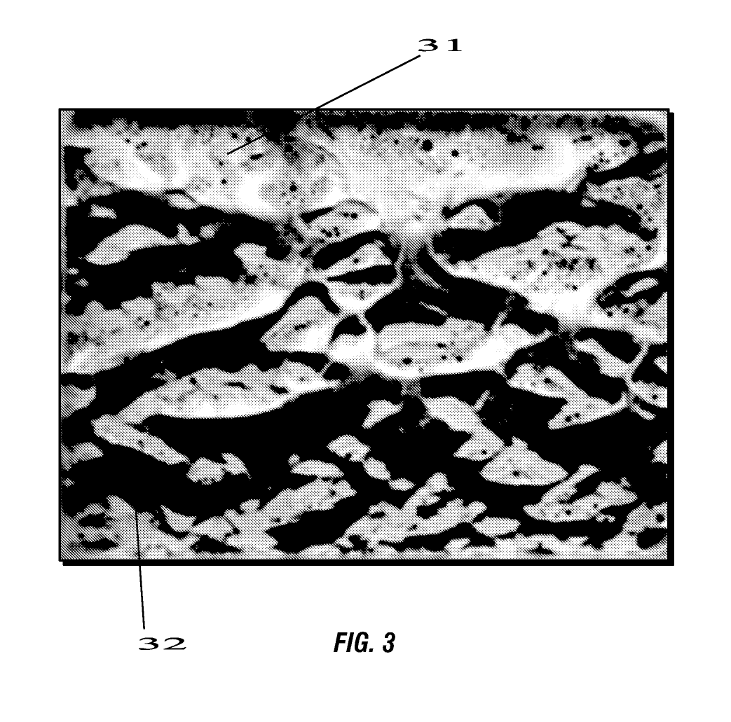

In this example, a fluid formulation of 0.36% guar solution in water and 3 ppa of 20/40 mesh sand, 20 ppt (2.4 g/L) polylactide fiber (length 6 mm, diameter 12 microns), and 0.5% of foaming agent (oxyalkylated alcohol) was introduced in the slot. Initially, the fluid appeared homogeneous. The slots were observed four hours later. As illustrated on FIG. 3, destabilization of the foam resulting in forming air bubbles (31) which were entrapped into the structure of the formed sand clusters (32) which significantly reduce their settling rate were observed.

We claim:

1. A method for treating a subterranean formation penetrated by a wellbore, comprising:
providing a treatment slurry comprising an energized fluid, a solid particulate and an anchorant;
injecting the treatment slurry into a fracture to form a substantially uniformly distributed mixture of the solid particulate and the anchorant; and
transforming the substantially uniform mixture into areas that are rich in solid particulate and areas that are substantially free of solid particulate,
wherein the solid particulate and the anchorant have substantially dissimilar velocities in the fracture and wherein said transforming results from said substantially dissimilar velocities.

2. The method of claim 1, wherein the solid particulate and the anchorant have different shapes, sizes, densities or a combination thereof.

3. The method of claim 1, wherein the anchorant has an aspect ratio higher than 6.

4. The method of claim 3, wherein the anchorant is a fiber, a flake, a ribbon, a platelet, a rod, or a combination thereof.

5. The method of claim 1, wherein the anchorant is a degradable material.

6. The method of claim 1, wherein the energized fluid has a foam quality of from 20 to 95%.

7. The method of claim 1, wherein the treatment slurry is a proppant-laden hydraulic fracturing fluid and the solid particulate is a proppant.

8. The method of claim 1, wherein the transforming is achieved by allowing the substantially uniformly injected solid particulate to settle in the fracture for a period of time.

9. The method of claim 1, wherein the injecting is achieved by pumping the treatment slurry under a pressure sufficient to create the fracture or maintain the fracture opened in the subterranean formation.

10. The method of claim 1, wherein the transforming is achieved before or during flowing back of the treatment fluid.

11. The method of claim 1, wherein the transforming is achieved before fracture closure.

12. The method of claim 1, wherein the substantially uniformly distributed mixture is formed in at least a portion of the fracture.

13. A composition, comprising:
An energized fluid;
a plurality of solid particulates; and
an anchorant;
wherein the composition is capable of transforming via settling from a first state of being substantially homogeneously mixed to a second state comprising portions that are rich of the solid particulates and portions that are substantially free of the solid particulates.

14. The composition of claim 13, wherein the anchorant has a substantially dissimilar flow characteristic from that of the solid particulate.

15. The composition of claim 13, wherein the anchorant has an aspect ratio higher than 6.

16. The composition of claim 13, wherein the portions that are rich in solid particulates comprise a matrix of the anchorant filled with the solid particulates.

17. The composition of claim 15, wherein the anchorant is a fiber, a flake, a ribbon, a platelet, a rod, or a combination thereof.

18. The composition of claim 13, wherein the treatment slurry is a proppant-laden hydraulic fracturing fluid and the solid particulate is a proppant.

19. The composition of claim 13, wherein the solid particulate is present in the treatment slurry in an amount of less than 22 vol %.

20. The composition of claim 13, wherein the anchorant is present in the treatment slurry in an amount of less than 5 vol %.

21. The composition of claim 13, wherein the viscosity of the carrying fluid is from 10 Pa·s to 500 Pa·s at the range of shear rates 0.001-0.1s⁻¹ when transforming the composition from the first to the second state.

22. The composition of claim 13, wherein the yield stress of the carrying fluid is less than 5 Pa when transforming the composition from the first to the second state.

23. The composition of claim 13, wherein said treatment slurry comprises more than one type of solid particles and/or more than one type of anchorant.

24. A method, comprising:
providing a slurry comprising an energized fluid, a solid particulate and an anchorant;
flowing the slurry into a void to form a substantially uniformly distributed mixture of the solid particulate and the anchorant; and
transforming the substantially uniformly distributed mixture into areas that are rich of solid particulate and areas that are substantially free of solid particulate,
wherein the solid particulate and the anchorant have substantially dissimilar velocities in the void and wherein said transforming is resulted from said substantially dissimilar velocities.

25. A method of designing a treatment, comprising:
considering a fracture dimension;
selecting an anchorant having a dimension comparable to the fracture dimension;
selecting a solid particulate having a substantially different settling velocity from the anchorant;
formulating a treatment fluid comprising the solid particulate and the anchorant such that the treatment fluid is capable of transforming via settling from a first state of being substantially homogeneously mixed to a second state comprising portions that are rich of the solid particulates and portions that are substantially free of the solid particulates.

26. The method of claim 25, wherein the fracture dimension is width.

27. A method for treating a subterranean formation penetrated by a wellbore, comprising:
providing a treatment slurry comprising an energized fluid, a solid particulate and an anchorant;
injecting the treatment slurry into a fracture to form a substantially uniformly distributed mixture of the solid particulate and the anchorant;
wherein the substantially uniform mixture is transformable into areas that are rich in solid particulate and areas that are substantially free of solid particulate, and
wherein the solid particulate and the anchorant have substantially dissimilar velocities in the fracture and wherein said transformability arises from said substantially dissimilar velocities.

28. A method, comprising:
providing a slurry comprising an energized fluid, a solid particulate and an anchorant;
flowing the slurry into a void to form a substantially uniformly distributed mixture of the solid particulate and the anchorant; and
wherein the substantially uniformly distributed mixture is transformable into areas that are rich of solid particulate and areas that are substantially free of solid particulate,
wherein the solid particulate and the anchorant have substantially dissimilar velocities in the void and wherein said transformability arises from said substantially dissimilar velocities.
